(19) United States
(12) Patent Application Publication
(10) Pub. No.: US 2010/0183105 A1
(43) Pub. Date: Jul. 22, 2010

(54) OFDM RECEIVER

(75) Inventors: Kazuhiko Takeyama, Sendai-shi (JP); Takashi Enoki, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/676,134

(22) PCT Filed: Sep. 7, 2007
(86) PCT No.: PCT/JP2007/067521

§ 371 Date: Mar. 2, 2010

(51) Int. Cl. H04L 27/00

(52) U.S. Cl. 375/346

(57) ABSTRACT

An OFDM receiver (100) has an FFT circuit (107c), an OFDM demodulating section (107) which performs OFDM demodulation for the received OFDM signal, a D/U (Desire to Undesire ratio) measuring section (106a) which measures the D/U in accordance with the OFDM-demodulated signal, a window function processing section (107b) provided at the preceding stage of the FFT circuit (107c), and a selecting section (106b) which switches the factors of the window function processing section (107b) in accordance with the D/U measured by the D/U measuring section (106a). This ensures elimination of interfering waves excellently with relatively simple configuration and low power consumption while suppressing deterioration in the BER due to processing of the window function.

### TECHNICAL FIELD

The present invention relates to an OFDM receiving apparatus and relates to a technique for removing undesired waves included in a received OFDM signal.

### BACKGROUND ART

In a mobile communication system, an OFDM (Orthogonal Frequency Division Multiplexing) scheme, which is a transmission scheme of high frequency use efficiency, is studied for a practical use (see Non-Patent Document 1). An OFDM signal adopts a digital modulation scheme for transmitting digital information using a plurality of orthogonal subcarriers, and has an advantage of, for example, enabling processing in subcarrier units (i.e. enabling processing to be divided in subcarrier units) in addition to an advantage of improving the efficiency of frequency use.

By the way, in a receiving apparatus, it is important to remove unwanted elements such as undesired waves and interfering waves included in a received signal. For example, taking into account the relationship between a mobile telephone in the third generation (3G) system and the super third generation (S3G) system, it is assumed that, in the initial stage of starting services of the S3G system, services of the S3G system and services of the 3G system are performed at the same time in the 2 [GHz] band. In this case, signals of the 3G system may be strong undesired waves for signals of the S3G system.

Up till now, in a receiving apparatus, it is general to provide an analog filter before an AD conversion circuit that performs analog-to-digital conversion of a received signal and suppress undesired waves by this analog filter. In this case, as a suppressing amount in the analog filter, all undesired waves that can be received as input in the system are demanded to be suppressed in the performance.

For example, Patent Document 1 discloses a conventional technique for removing unwanted elements such as undesired waves in an OFDM receiving apparatus. FIG. 22 shows a general configuration of that OFDM receiving apparatus. OFDM receiving apparatus 10 in FIG. 22 inputs a received OFDM signal received at antenna 11 in OFDM signal processing section 15 via front end section 12, quadrature demodulation section 13 and analog-to-digital conversion section (AD conversion section) 14 in order. Also, AD conversion section 14 samples signals of a band equal to or greater than the band required for demodulation (generally, the speed needs to be improved by multiples of two upon performing an FFT). OFDM signal processing section 15 is provided with FFT (Fast Fourier Transform) processor 16, unwanted element remover 17 and demodulation processor 18. FFT processor 16 converts a time domain signal into a frequency domain signal by performing an FFT of a signal obtained by performing AD conversion. Unwanted element remover 17 separates the signal obtained by FFT processing into the desired wave signal and the undesired wave signal, removes the unwanted elements other than the desired wave, and outputs the desired wave signal to demodulation processor 18. Here, unwanted element remover 17 performs processing after FFT processor 16 because it is possible to easily separate between the desired wave signal and the disturbing signal after FFT processing. Demodulation processor 18 acquires received data by applying, for example, error correction decoding processing to the signal from which unwanted elements are removed.

Also, for example, Patent Document 2 discloses a conventional technique for removing undesired waves in an OFDM receiving apparatus. Specifically, Patent Document 2 proposes a method for alleviating degradation in FFT processing by improving the orthogonality by frequency adjustment, and thereby suppressing undesired waves.
Patent Document 1: Japanese Patent Application Laid-Open No. 2003-143103
Patent Document 2: Japanese Patent Application Laid-Open No. 2005-531259
Non-Patent Document 1: 3GPP TR 25.814

### DISCLOSURE OF INVENTION

### Problems to be Solved by the Invention

By the way, in an OFDM receiving apparatus, if undesired waves adopt a modulation scheme different from that of desired waves and have strong power, leak error is caused in FFT processing. This occurs mainly when undesired waves are discontinuous. Therefore, even if undesired waves are removed after an FFT circuit as shown in Patent Document 1, the C/N (Carrier to Noise ratio) of desired waves is already degraded due to leak error caused by undesired waves, and, consequently, there is a limit to signal quality improvement.

By contrast, if undesired waves are suppressed before FFT processing, for example, the use of an analog filter as above, the use of frequency adjustment and the use of a digital filter are possible.

However, if a digital filter is provided before FFT processing, there are disadvantages that a circuit scale increases and in-band deviation (amplitude, phase) occurs.

Also, upon improving orthogonality by frequency adjustment, even if the orthogonality can be improved, it is not possible to improve leak error caused by FFT processing.

Also, upon suppressing undesired waves using only an analog filter, it is necessary to always operate an analog filter of high order in all M-ary modulation settings (including QPSK, 16 QAM, 64 QAM, and so on), and therefore there is a disadvantage that power consumption increases. Also, an analog filter of high order, in which in-band deviation and IQ deviation do not occur, has a disadvantage of a complicated configuration.

In view of the above points, it is therefore an object of the present invention to provide an OFDM receiving apparatus that can sufficiently suppress undesired waves included in a received OFDM signal with a relatively simple configuration and low power consumption.

### Means for Solving the Problem

An aspect of the OFDM receiving apparatus of the present invention employs a configuration having: an orthogonal frequency division multiplexing demodulation section that contains a fast Fourier transform circuit and performs orthogonal frequency division multiplexing demodulation of a received orthogonal frequency division multiplexing signal; a desired-to-undesired ratio measuring section that measures a desired-to-undesired ratio based on the signal obtained by performing the orthogonal frequency division multiplexing demodulation; a window function processing section that processes the orthogonal frequency division signal before the fast Fourier transform circuit; and a control section that switches coefficients of the window function processing section based on the desired-to-undesired ratio measured in the desired-to-undesired ratio measuring section.

An aspect of the OFDM receiving apparatus of the present invention employs a configuration having: an orthogonal frequency division multiplexing demodulation section that contains a fast Fourier transform circuit and performs orthogonal frequency division multiplexing demodulation of a received orthogonal frequency division multiplexing signal; a desired-to-undesired ratio measuring section that measures a desired-to-undesired ratio based on the signal obtained by performing the orthogonal frequency division multiplexing demodulation; a window function processing section that is provided before the fast Fourier transform circuit; an analog filter that processes the orthogonal frequency division multiplexing signal before the window function processing section and can control a filter order; and a control section that switches coefficients of the window function processing section and the filter order of the analog filter based on the desired-to-undesired ratio measured in the desired-to-undesired ratio measuring section, a carrier-to-noise ratio of the signal obtained by performing the orthogonal frequency division multiplexing demodulation and a required carrier-to-noise ratio.

### Advantageous Effect of the Invention

According to the present invention, it is possible to realize an OFDM receiving apparatus that can sufficiently suppress undesired waves included in a received OFDM signal with a relatively simple configuration and low power consumption.

### BRIEF DESCRIPTION OF DRAWINGS

FIG. 1 is a block diagram showing the configuration of an OFDM receiving apparatus according to Embodiment 1 of the present invention;

FIG. 2 shows output waveforms in an FFT circuit;

FIG. 3 is a block diagram showing the configuration of a window function processing section;

FIG. 4 illustrates window function coefficient set 1, FIG. 4A shows characteristics of a window function processing section upon using window function coefficient set 1, and FIG. 4B shows coefficients of window function coefficient set 1;

FIG. 5 illustrates window function coefficient set 2, FIG. 5A shows characteristics of a window function processing section upon using window function coefficient set 2, and FIG. 5B shows coefficients of window function coefficient set 2;

FIG. 6 is a flowchart showing the flow of data receiving processing in an OFDM receiving apparatus according to Embodiment 1;

FIG. 7A shows a frequency allocation example of desired waves and undesired waves in a radio band, and FIG. 7B shows a frequency allocation example of desired waves and undesired waves in a baseband band;

FIG. 8 shows D/U performance in an OFDM receiving apparatus according to Embodiment 1;

FIG. 9 shows C/N performance in an OFDM receiving apparatus according to Embodiment 1;

FIG. 10 shows a state where leak error is suppressed by FFT processing in an OFDM receiving apparatus according to Embodiment 1,

FIG. 10A shows leak error characteristics without a window function,

FIG. 10B shows leak error characteristics in the case of using window function coefficient set 1, and FIG. 10C shows leak error characteristics in the case of using window function coefficient set 2;

FIG. 11 shows filter characteristics of an analog discrete filter;

FIG. 12 shows a state of in-band C/N deviation in the case of using a filter having in-band deviation;

FIG. 13 shows a state of a signal including strong input undesired waves;

FIG. 14 is a block diagram showing the configuration of an OFDM receiving apparatus according to Embodiment 2;

FIG. 15 shows the amount of undesired waves suppressed by switching the order of a variable low-pass filter;

FIG. 16 shows a configuration example of a variable low-pass filter;

FIG. 17 shows the amount of neighboring undesired waves suppressed by a variable low-pass filter;

FIG. 18 shows the configuration of a table that determines the order of a variable low-pass filter and window function coefficients based on D/U information and C/N information;

FIG. 19A shows required C/N in the case of not using a window function, FIG. 19B shows required C/N in the case of using window function coefficient set 1, and FIG. 19C shows required C/N in the case of using window function coefficient set 2;

FIG. 20A shows allowable D/U in the case of not using a window function, FIG. 20B shows possible D/U in the case of using window function coefficient set 1, and FIG. 20C shows possible D/U in the case of using window function coefficient set 2;

FIG. 21 is a flowchart showing the flow of data receiving processing in an OFDM receiving apparatus according to Embodiment 2; and

FIG. 22 is a block diagram showing a configuration example of a conventional OFDM receiving apparatus.

### BEST MODE FOR CARRYING OUT THE INVENTION

Embodiments of the present invention will be explained below in detail with reference to the accompanying drawings.

### Embodiment 1

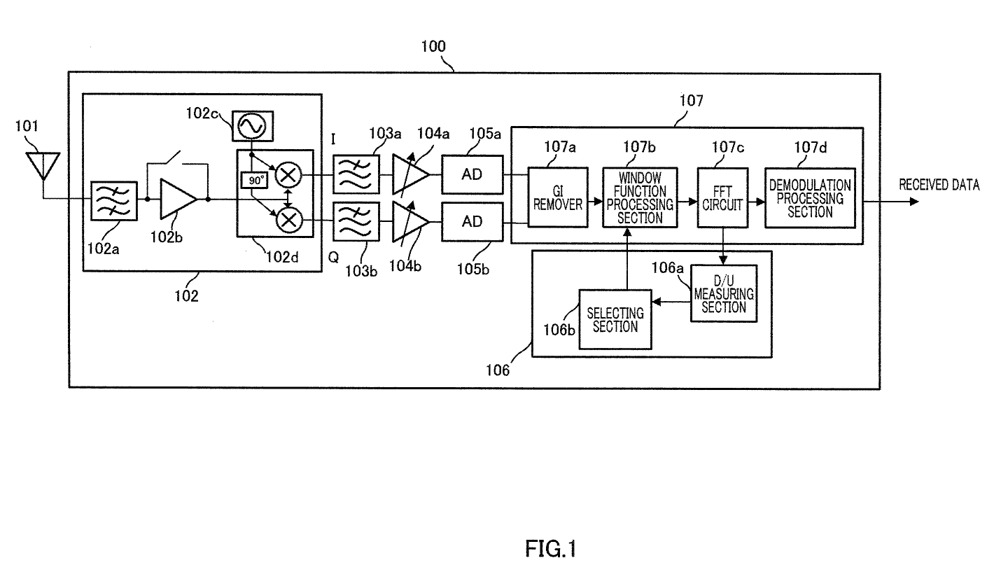

FIG. 1 shows the configuration of an OFDM receiving apparatus according to Embodiment 1 of the present invention. OFDM receiving apparatus 100 is mounted on, for example, a mobile telephone device.

In OFDM receiving apparatus 100, antenna duplexer 102a of front end section 102 receives as input a signal received at antenna 101. Actually, antenna duplexer 102a receives as input an OFDM transmission signal acquired by an OFDM transmitting apparatus (not shown) in addition to a signal received at antenna 101. Antenna duplexer 102a switches between outputting the OFDM signal received at the antenna to the subsequent circuit in FIG. 1 and outputting the OFDM transmission signal acquired by the OFDM transmitting apparatus (not shown) to antenna 101.

The OFDM received signal outputted from antenna duplexer 102a is received as input in low noise amplification section 102b. Low noise amplification section 102b amplifies the OFDM received signal by low noise and outputs the amplified OFDM received signal to quadrature demodulation section 102d. Quadrature demodulation section 102d acquires received baseband signals of the I (In-phase) component and Q (Quadrature) component by multiplying the OFDM received signal by a local signal acquired at local signal oscillation section 102c with a phase difference of 90 [°].

The received baseband signals of the I component and Q component are received as input in OFDM demodulation section 107 via low-pass filters 103a and 103b, AGC (Automatic Gain Control) sections 104a and 104b and AD conversion sections 105a and 105b.

First, OFDM demodulation section 107 forms a signal having a signal length of FFT processing unit, by removing a guard interval in GI remover 107a. The signal without a guard interval is received as input in window function processing section 107b.

Window function processing section 107b suppresses the undesired waves included in the received OFDM signal received as input, by weighting processing using a window function. Here, window function processing section 107b sets a coefficient used for window function processing, based on a control signal from control section 106. In the present embodiment, the Tukey window function is used as a window function.

The received OFDM signal on which processing by window function have been performed will be subjected to FFT processing in FFT circuit 107c. By this means, a time domain signal is converted into a frequency domain signal. Incidentally, in OFDM receiving apparatus 100, the synchronization timing is selected in a synchronization section (not shown), and the timings of GI remover 107a and FFT circuit 107c are controlled at the selected timing.

The signal on which FFT processing have been performed will be subjected to, for example, correction processing based on channel estimation processing and the estimated value, and error correction decoding processing in demodulation processing section 107d for providing received data.

Also, the signal on which FFT processing have been performed is received as input in D/U (Desired-to-Undesired ratio) measuring section 106a of control section 106. D/U measured in D/U measuring section 106a is outputted to selecting section 106b. Based on D/U, selecting section 106b forms a control signal for designating coefficients used in window function processing section 107b, and outputs the control signal to window function processing section 107b.

By the way, in an OFDM communication apparatus, given the structure of the FFT circuit, the squares of two subcarriers are often used. However, a usable frequency band is determined in wireless communication, and, for example, as disclosed in Non-Patent Document 1, there are cases where, although an FFT band of 15.36 [MHz] is formed to use 1024 subcarriers in a system of a wireless band of 10 [MHz], only 601 subcarriers are used as available subcarriers. In this case, 423 subcarriers are defined as unused subcarriers, and their power is set 0.

Thus, when an FFT band is wider than the bandwidth of a desired wave, an OFDM receiving apparatus takes in an undesired wave in addition to a desired wave. An OFDM signal can be divided in subcarrier units, that is, it is possible to separate between a desired wave and undesired wave.

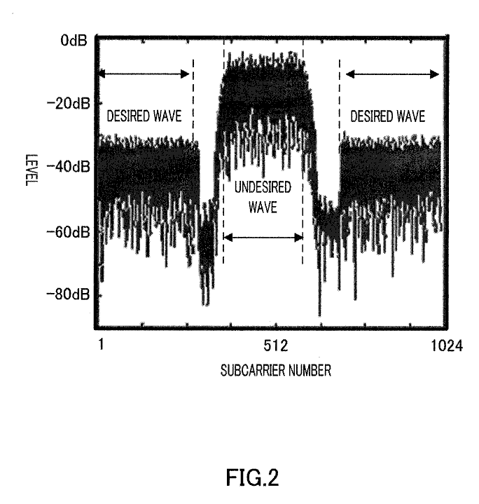

In OFDM receiving apparatus 100 of the present embodiment, D/U measuring section 106a acquires, for example, the subcarrier information shown in FIG. 2 from an output of FFT circuit 107c, and calculates a level ratio between a desired wave band and an undesired wave band (i.e. D/U).

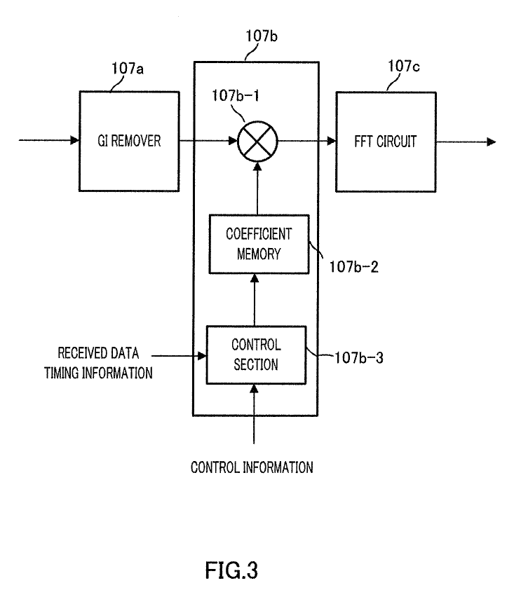

FIG. 3 shows the configuration of window function processing section 107b. Window function processing section 107b is provided with multiplier 107b-1, coefficient memory 107b-2 and control section 107b-3. Multiplier 107b-1 receives as input an output of GI remover 107a and a window function coefficient outputted from coefficient memory 107b-2, and multiplies these.

Control section 107b-3 receives as input control information outputted from selecting section 106b and received data timing information acquired by a synchronization section (not shown), and controls the reading of coefficients from coefficient memory 107b-2 based on these information.

To be more specific, coefficient memory 107b-2 memorizes a plurality of window function coefficient sets to support D/U, and selects one of the plurality of window function coefficient sets according to control information outputted from selecting section 106b. Also, each window function coefficient set memorizes window function coefficients associated with received data timings (sampling data), and one coefficient is outputted according to each received data timing.

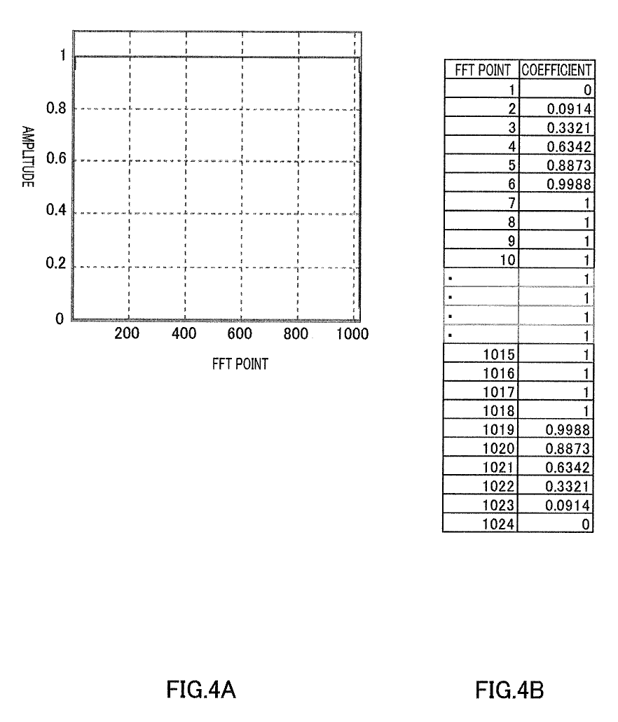

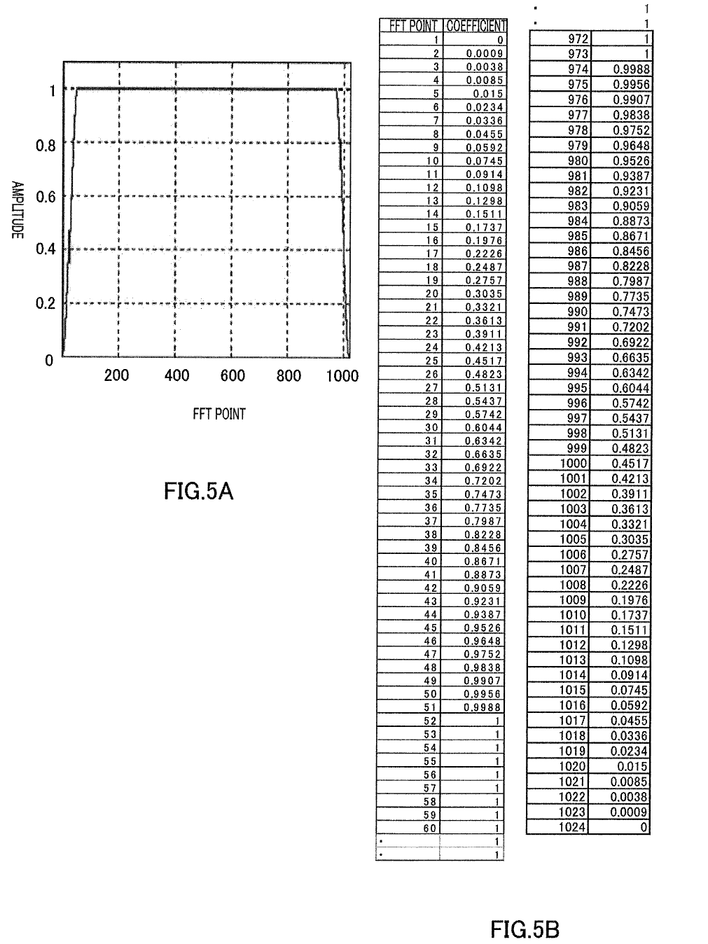

In the present embodiment, the coefficient memory memorizes window function coefficient set 1 shown in FIG. 4 and window function coefficient set 2 shown in FIG. 5. In FIG. 4, FIG. 4A shows output characteristics of window function processing section 107b in the case of using window function coefficient set 1, and FIG. 4B shows specific coefficients of window function coefficient set 1. Similarly, in FIG. 5, FIG. 5A shows output characteristics of window function processing section 107b in the case of using window function coefficient set 2, and FIG. 5B shows specific coefficients of window function coefficient set 2.

As shown in FIG. 4B and FIG. 5B, coefficients associated with FFT points are memorized, and, by reading the coefficients associated with FFT points in multiplier 107b-1 from coefficient memory 107b-2, data associated with FFT points and their coefficients are multiplied.

Incidentally, FIG. 4 and FIG. 5 show window function coefficient sets for realizing the Tukey window function. Here, although window functions include, for example, the Kaiser window function in addition to the Tukey window function, the present inventors have verified from a simulation result that, by using the Tukey window function, it is possible to sufficiently suppress leak error due to undesired waves upon FFT processing. Therefore, the present embodiment uses the Tukey window function as a window function. In this case, a window function different from the Tukey window function is also applicable as a window function.

Also, in the present embodiment, the FFT size in FFT circuit 107c is 1024 points, and therefore each window function set provides 1024 coefficients.

Next, the operations of OFDM receiving apparatus 100 according to the present embodiment will be explained.

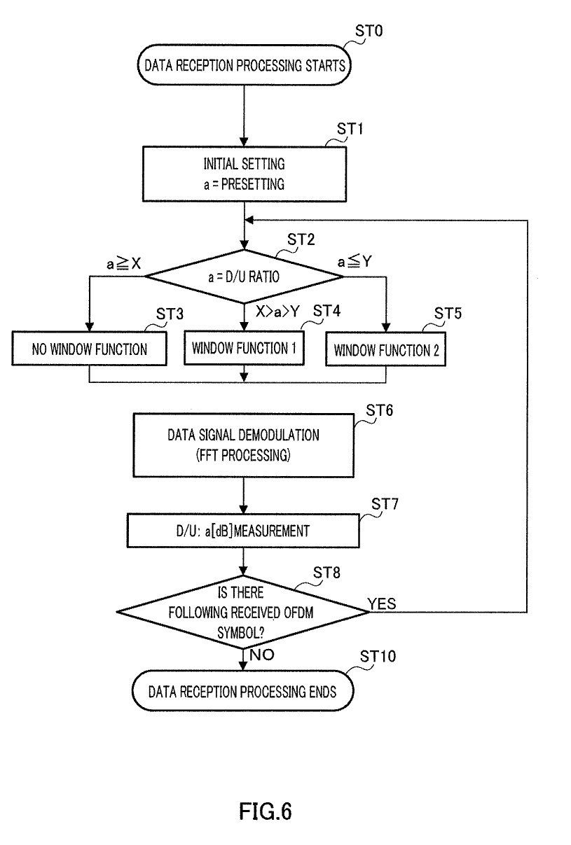

FIG. 6 shows the flow of data receiving processing in OFDM receiving apparatus 100. OFDM receiving apparatus 100 starts data receiving processing in step ST 0, sets (presets) the initial value of the value “a” of D/U in subsequent step ST 1, and moves the step to step ST 2.

In step ST 2, selecting section 106b performs threshold decision of the value “a” of D/U using thresholds X and Y. When selecting section 106b acquires a decision result that D/U is equal to or greater than threshold X (a≧X) in step ST 2, this means that little leak error occurs upon FFT processing without suppressing undesired waves by window function processing, and, consequently, the step moves to step ST 3 not to perform window function processing in window function processing section 107b (e.g. all window function coefficients are set to “1”).

Also, when selecting section 106b acquires a decision result that D/U is less than threshold X but is greater than threshold Y (X>a>Y) in step ST 2, the step moves to step ST 4 so that window function processing section 107b selects window function coefficient set 1 (in FIG. 4) as a window function and performs window function processing.

Further, when selecting section 106b acquires a decision result that D/U is equal to or less than threshold Y in step ST 2, the step moves to step ST 5 so that window function processing section 107b selects window function coefficient set 2 (in FIG. 5) and performs window function processing.

After processing in step ST 3, step ST 4 or step ST 5, the step moves to step ST 6, and OFDM receiving apparatus 100 demodulates a data signal by performing FFT processing in FFT circuit 107c and demodulation processing in demodulation processing section 107d.

Next, in step ST 7, OFDM receiving apparatus 100 measures D/U in D/U measuring section 106a.

Next, in step ST 8, OFDM receiving apparatus 100 decides whether or not a following received OFDM symbol is present, and, if there is no following received OFDM symbol, moves the step to step ST 10 to finish the data receiving processing. By contrast with this, if there is a following received OFDM symbol, the step returns to step ST 2 to perform subsequent processing based on D/U measured in step ST 7.

Thus, in OFDM receiving apparatus 100, by selecting a window function coefficient based on D/U and further selecting whether or not to perform window function processing based on D/U, it is possible to sufficiently suppress leak error due to undesired waves upon FFT processing with a relatively simple configuration and low power consumption.

By the way, in a general OFDM receiving apparatus, by performing FFT processing in demodulation process, it is possible to separate between a desired wave and an undesired wave by this FFT process. However, when D/U is larger, FFT-processed data becomes discontinuous due to the influence of undesired wave signals (i.e. the end of data and the beginning of data are not connected continuously), and, as a result, noise occurs in FFT processing. This noise is generally referred to as “leak error.”

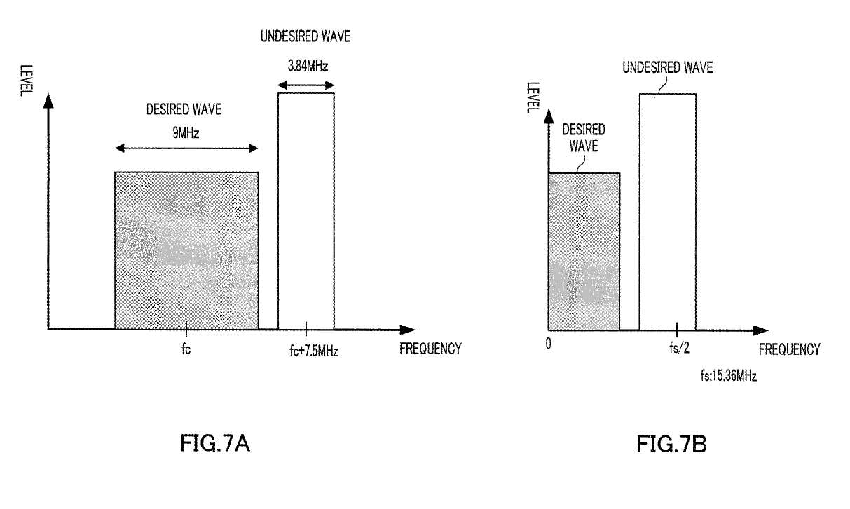

For example, a case will be explained where, in a radio band, OFDM receiving apparatus 100 receives a desired wave and undesired wave subjected to frequency allocation shown in FIG. 7A. In a baseband band, these signals are subjected to frequency allocation shown in FIG. 7B. Also, FIG. 7 shows example cases where the sampling clock of AD conversion sections 105a and 105b is 15.36 [MHz]. Incidentally, assume that it is possible to suppress an undesired wave outside an FFT band by duplexer 102a and low-pass filters 103a and 103b, to such an extent that there is no influence of returned undesired wave to a desired wave signal in AD conversion section s 105a and 105b.

Here, assume that the desired wave refers to an OFDM signal of a bandwidth of 9 [MHz] (modulation scheme of 16 QAM, coding rate of ¾, FFT size of 1024, the number of subcarriers of 601), and the undesired wave refers to a signal of a bandwidth of 3.84 [MHz] and a modulation scheme of QPSK.

Also, assume that the number of bits in AD conversion sections 105a and 105b is large such that there is little influence of quantization noise.

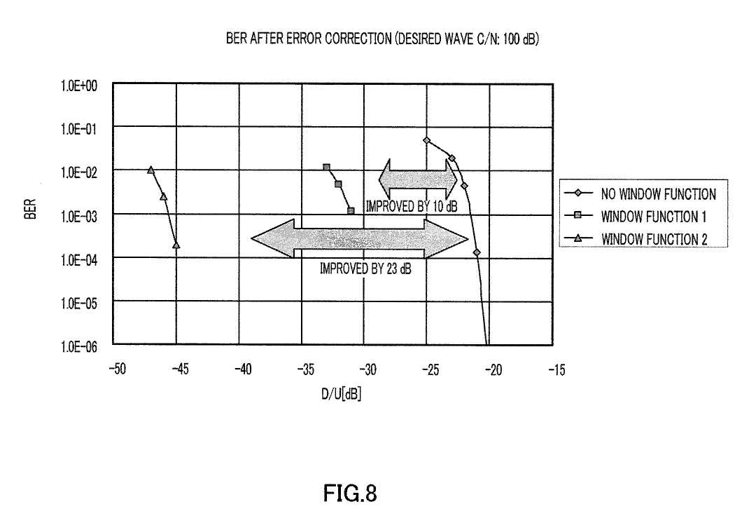

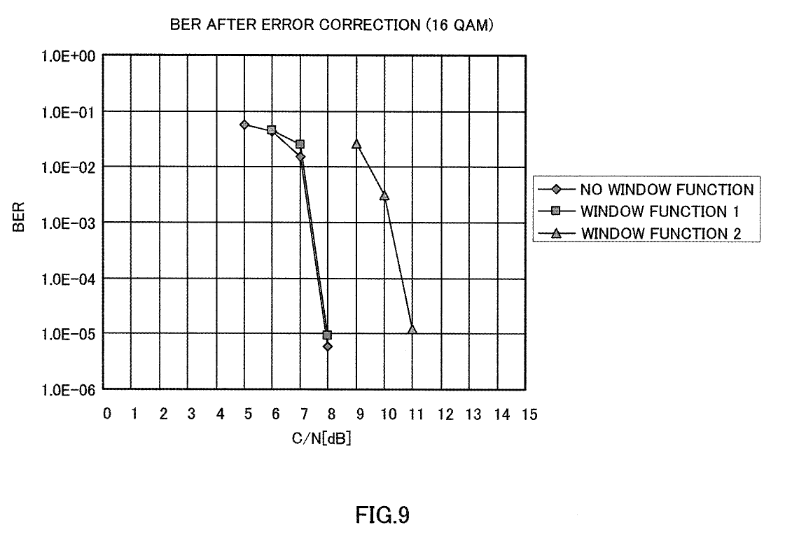

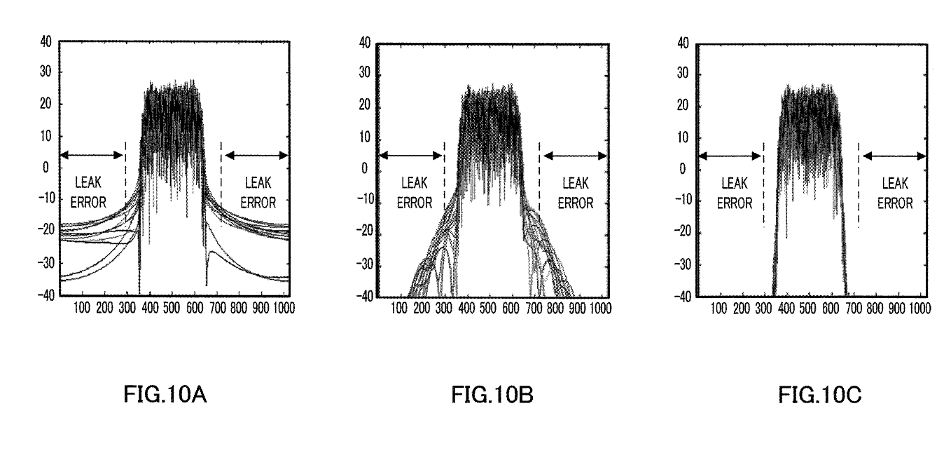

In such conditions, as a result of operating OFDM receiving apparatus 100 of the present embodiment, the simulation results shown in FIG. 8, FIG. 9 and FIG. 10 are acquired.

FIG. 8 shows D/U performance in OFDM receiving apparatus 100 and the relationship between D/U and BER (Bit Error Rate). In FIG. 8, the horizontal axis represents D/U [dB] and the vertical axis represents BER after error correction.

FIG. 9 shows C/N (Carrier to Noise Ratio) characteristics in OFDM receiving apparatus 100 and the relationship between C/N and BER. In FIG. 9, the horizontal axis represents required C/N [dB] and the vertical axis represents BER after error correction. The simulation result in FIG. 9 shows static characteristics in the case where the modulation scheme of desired waves is 16 QAM.

FIG. 10 shows a state where leak error due to FFT processing is suppressed in OFDM receiving apparatus 100. FIG. 10A shows leak error characteristics without a window function, FIG. 10B shows leak error characteristics in the case of using window function coefficient set 1 (in FIG. 4), and FIG. 10C shows leak error characteristics in the case of using window function coefficient set 2 (in FIG. 5). These figures show characteristics upon FFT processing of undesired waves and that combine 14 characteristics. It is understood from FIG. 10A that, although leak error is small in the case where undesired waves are practically continuous, leak error is large in the case where undesired waves are discontinuous, and there is a difference of about 20 [dB] between these cases.

As shown in FIG. 8, in the case of “no window function,” that is, in the case of not performing window function processing in window function processing section 107b, U/D is −22 [dB] and BER is 1E-3. By contrast with this, in the case of using window function coefficient set 1, D/U performance improves by 10 [dB]. Also, in the case of using window function coefficient set 2, D/U performance improves by 23 [dB].

Also, as shown in FIG. 9, to acquire BER of 1.0E-3, it is understood that, compared to the case of “no window function,” the required C/N increases by 0.1 [dB] (i.e. the required C/N degrades by 0.1 [dB]) in the case of using window function coefficient set 1, and the required C/N increases by 2.8 [dB] (i.e. the required C/N degrades by 2.8 [dB]) in the case of using window function coefficient set 2.

It is understood from FIG. 8 and FIG. 9 that, in the case where D/U is 30 [dB], receiving performance improves by using window function coefficient set 1 rather than window function coefficient set 2. Taking into account the above, OFDM receiving apparatus 100 of the present embodiment performs threshold decision of D/U using threshold Y, and, based on a decision result, selects window function coefficients used in window function processing section 107b. Incidentally, in the present embodiment, thresholds X and Y explained in FIG. 6 are set to −20 and −30, respectively.

As described above, according to the present embodiment, by providing: OFDM demodulation section 107 that contains FFT circuit 107c and performs OFDM demodulation of a received OFDM signal; D/U measuring section 106a that measures D/U (Desired to Undesired ratio) based on the signal obtained by performing OFDM demodulation; window function processing section 107b processes the OFDM signal before FFT circuit 107c; and selecting section 106b that switches the coefficients of window function processing section 107b based on D/U measured in D/U measuring section 106a, it is possible to suppress BER degradation due to window function processing and sufficiently remove undesired waves with a relatively simple configuration and low power consumption.

That is, it is possible to realize a compact OFDM receiving apparatus that can suppress undesired waves by performing window function processing, without using a digital filter, even in the case where discontinuous undesired waves are received as input, and that can acquire received data of good error rate performance even in the case where strong undesired waves are received. Incidentally, in the case of replacing window function processing section 107b of the present embodiment with a digital filter in the above configuration, it is necessary to provide an FIR filter of seventeenth order or equivalent. In this case, 17 multipliers, delay circuits and adders are necessary, and therefore the circuit scale increases significantly. In the present embodiment, by using window function processing section 107b, it is possible to reduce the circuit scale significantly.

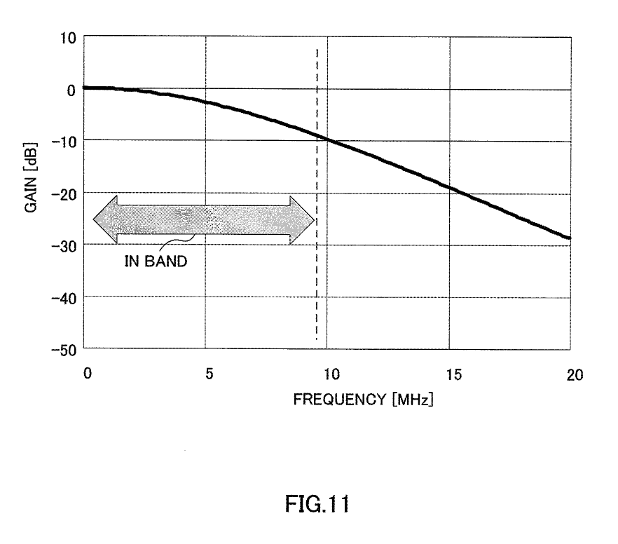

Also, recently, 1 CMOS LSI that forms an analog circuit and digital circuit into one chip is proposed. In such LSI, an analog filter that operates in a low voltage is necessary, and, consequently, it is difficult to adopt an analog filter circuit configuration using a conventional operational amplifier. Therefore, for example, an analog discrete filter using a switch and capacitor is proposed. This analog discrete filter will have low-order filter characteristics having the in-band deviation shown in FIG. 11, because the analog discrete filter of high order is difficult to provide.

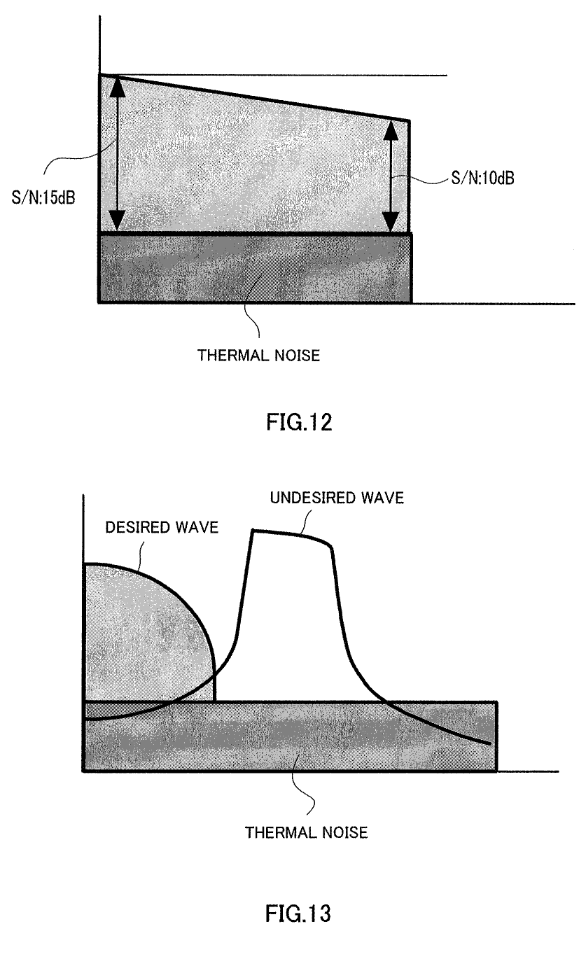

For an OFDM signal, generally, it is possible to perform channel estimation on a per subcarrier basis and use a filter having in-band deviation. Upon using a filter having in-band deviation, as shown in FIG. 12, although in-band C/N deviation occurs, it is possible to perform demodulation without problems if the required C/N is equal to or less than 10 [dB].

However, as shown in FIG. 13, if FFT processing is performed on a signal including a strong input undesired wave, the C/N of subcarriers near the undesired wave degrades due to leak error, and therefore receiving performance degrades. Even in this case, by performing window function processing shown in the present embodiment, it is possible to demodulate the signal without degradation.

Also, although a case has been described above with the present embodiment where D/U is measured based on an output of FFT circuit 107c, the method of measuring D/U is not limited to this.

### Embodiment 2

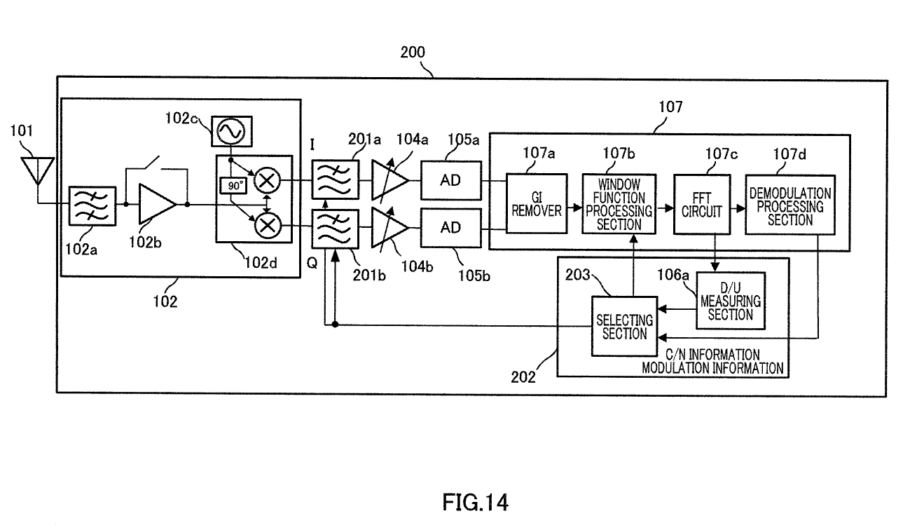

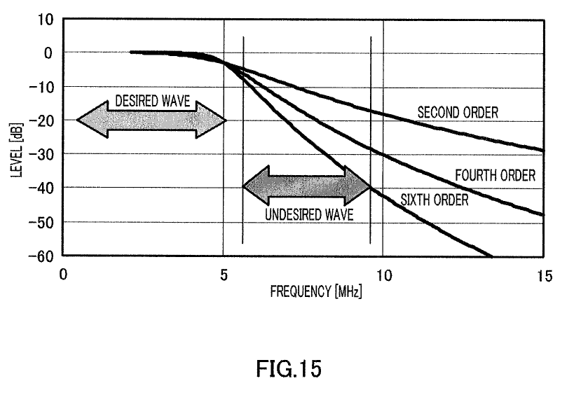

FIG. 14, in which the same components as in FIG. 1 are assigned the same reference numerals, shows the configuration of an OFDM receiving apparatus of the present embodiment. Compared to OFDM receiving apparatus 100 in FIG. 1, OFDM receiving apparatus 200 is provided with low-pass filters 201a and 201b instead of low-pass filters 103a and 103b. Also, selecting section 203 in control section 202 receives as input C/N (Carrier to Noise Ratio) and modulation scheme information acquired by demodulation processing section 107b. Generally, a mobile communication terminal measures S/N (Signal-to-Noise Ratio) information and reports it to a base station for performing TPC (Transmit Power Control) and adaptive modulation control. Demodulation processing section 107d calculates C/N from S/N and outputs C/N to selecting section 203.

Selecting section 203 controls window function coefficients and the filter orders of variable low-pass filters 201a and 201b based on D/U information, C/N information and modulation scheme information.

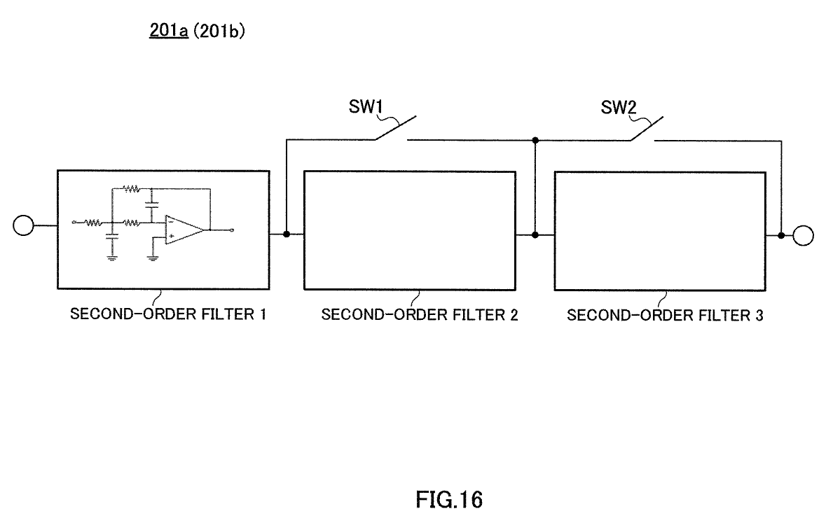

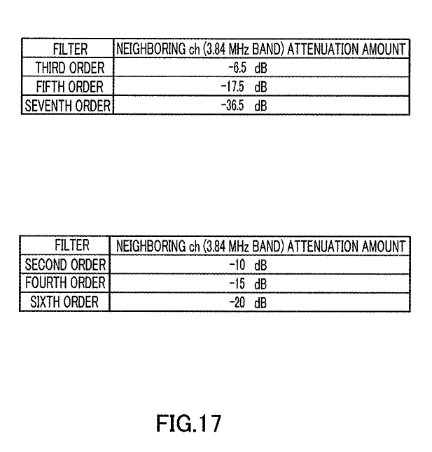

As variable low-pass filters 201a and 201b, for example, as shown in FIG. 15, a filter that can switch the amount of undesired waves suppressed by controlling the orders is used. FIG. 16 shows a configuration example of variable low-pass filters 201a and 201b. In FIG. 16, three second-order filters are cascade-connected, and, by switching between switches SW 1 and SW 2, it is possible to switch the orders. Each second-order filter adopts an active filter configuration, and LSI is applied to these filters. Also, when a second-order filter is not used, the power supply is turned off. FIG. 17 shows the amount of neighboring undesired waves suppressed in variable low-pass filters 201a and 201b.

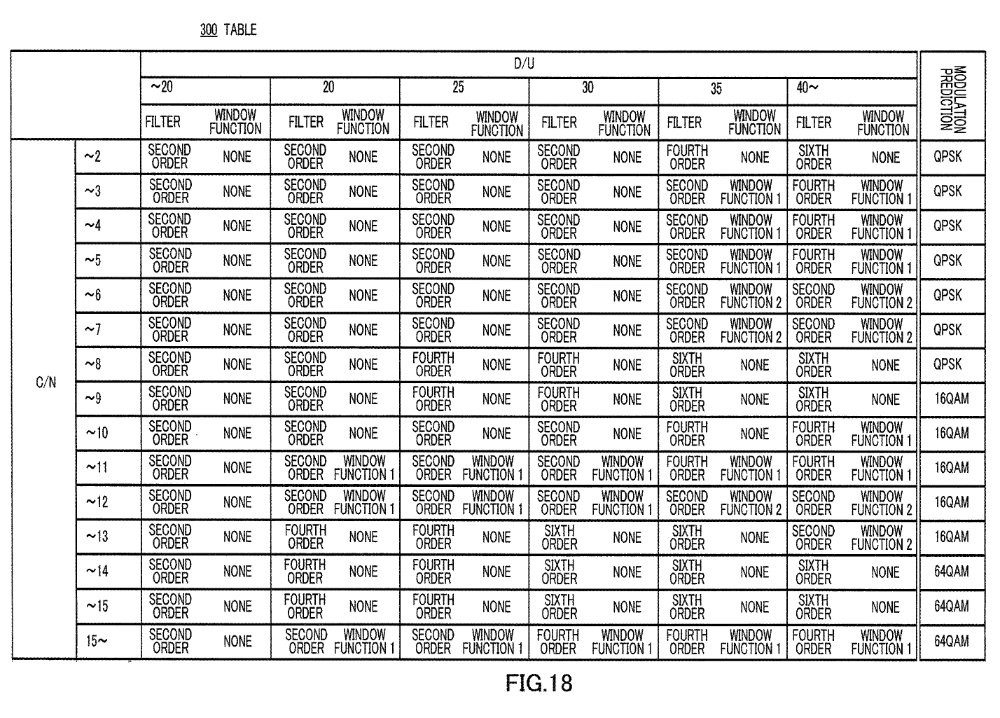

Selecting section 203 has the table shown in FIG. 18 and determines the orders of variable low-pass filters 201a and 201b and window function coefficients, using D/U information and C/N information as reading addresses.

Table 300 in FIG. 18 will be explained. Table 300 is designed so as to perform low power consumption without degrading throughput by optimizing the analog filter orders of variable low-pass filters 201a and 201b and a window function of window function processing section 107b based on D/U information and in-band CN information.

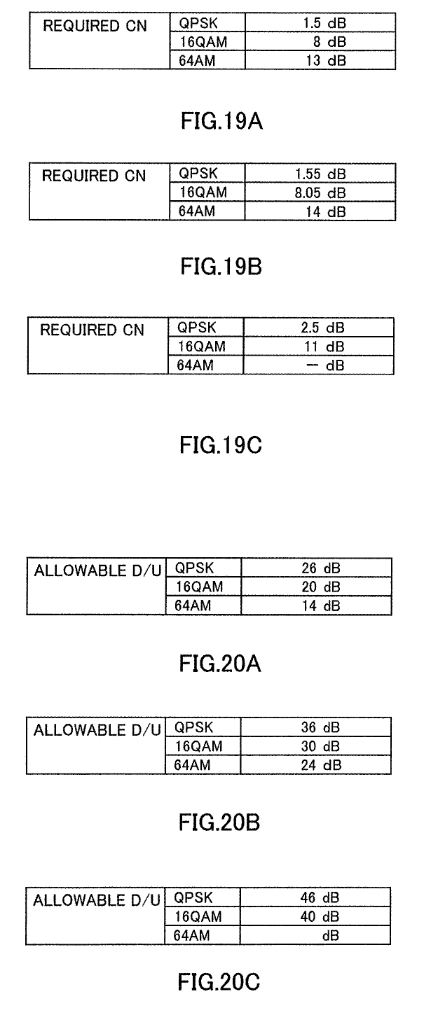

Generally, a mobile communication system has a feature that the improvement of throughput is small in the case where C/N with respect to a set modulation wave is above a certain value. For example, assume that OFDM receiving apparatus 200 can receive modulation signals of QPSK, 16 QAM and 64 QAM, and the required C/N of each modulation condition has the values shown in FIG. 19. FIG. 19A shows the required C/N in the case without window function, FIG. 19B shows the required C/N in the case of using window function coefficient set 1, and FIG. 19C shows the required C/N in the case of using window coefficient set 2.

Also, assume that possible D/U in the case of applying each window function (including no window function) is as shown in FIG. 20. FIG. 20A shows allowable D/U in the case without window function, FIG. 20B shows allowable D/U in the case of using window function coefficient set 1, and FIG. 20C shows allowable D/U in the case of using window function coefficient set 2.

In the setting without window function, the required C/N under each modulation condition is lower than in the setting using a window function. In the case of setting window function coefficient set 1, compared to the setting without window function, although the required C/N degrades little in the modulation conditions of QPSK and 16 QAM, degradation of 1 [dB] occurs upon 64 QAM. In the case of setting window coefficient set 2, compared to the setting without window function, the required CN degrades in the modulation conditions of QPSK and 16 QAM, and cannot be used upon 64 QAM.

As shown in FIG. 20, among the modulation conditions, the allowable D/U is the highest in the case of using window function coefficient set 2 (in FIG. 20C), and the allowable D/U in the case of using window function coefficient set 1 (in FIG. 20B) is higher than in the case without window function (in FIG. 20A).

In table 300, if the C/N of a received signal is near the required C/N of a presumed modulation wave, the orders of analog filters (i.e. variable low-pass filters 201a and 201b) are increased to suppress undesired waves. By contrast with this, if the C/N of a received signal is greater than the required C/N of the set modulation wave, the orders of analog filters (i.e. variable low-pass filters 201a and 201b) are decreased to suppress undesired waves mainly by window function processing.

Next, the operations of OFDM receiving apparatus 200 of the present embodiment will be explained.

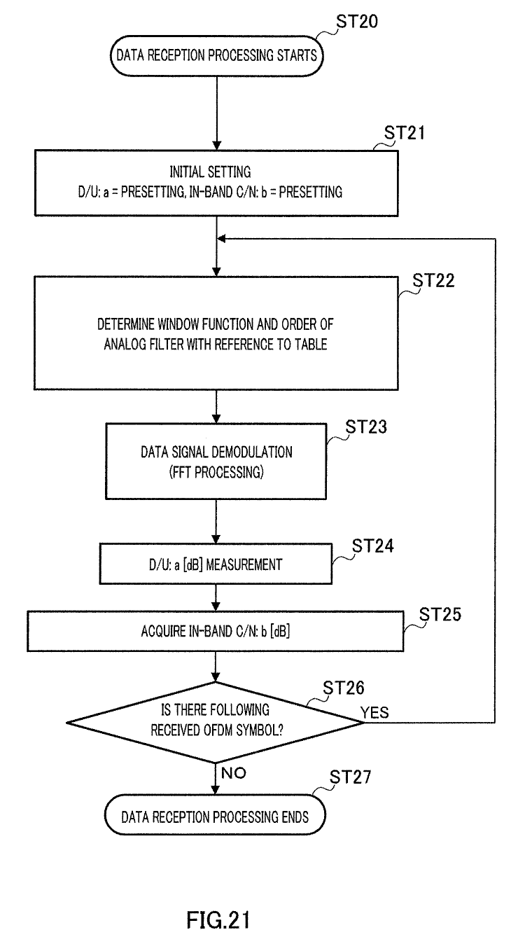

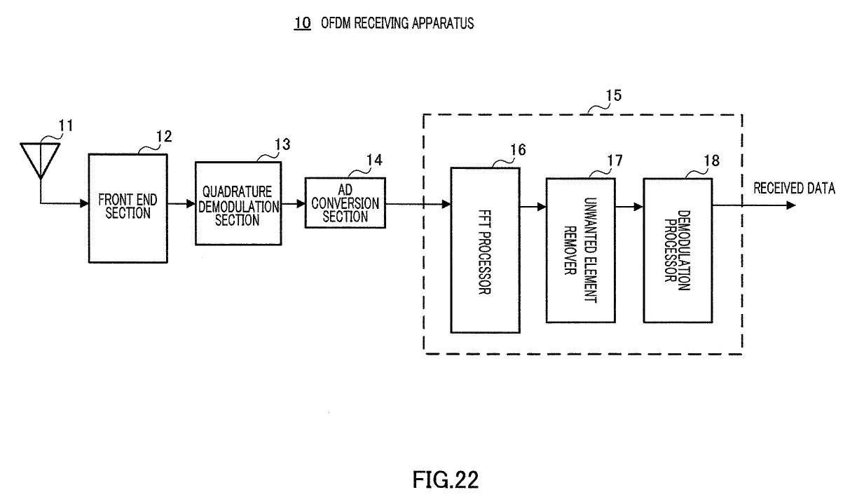

FIG. 21 shows the flow of data reception processing in OFDM receiving apparatus 200. OFDM receiving apparatus 200 starts data reception processing in step ST 20, sets (presets) the initial values of the value “a” of D/U and the value “b” of C/N in subsequent step ST 21, and moves the step to step ST 22.

In step ST 22, selecting section 203 selects a window function coefficient set used in window function processing section 107b and the orders of analog filters (i.e. variable low-pass filters 201a and 201b), with reference to table 300.

Next, OFDM receiving apparatus 200 moves the step to ST 23 and demodulates a data signal by performing FFT processing in FFT circuit 107c and demodulation processing in demodulation processing section 107d.

Next, OFDM receiving apparatus 200 measures D/U in D/U measuring section 106a in step ST 24. Also, OFDM receiving apparatus 200 acquires in-band C/N in demodulation processing section 107d in step ST 25.

Next, OFDM receiving apparatus 200 decides whether or not a following received OFDM symbol is present in step ST 26, and, if there is no following received OFDM symbol, moves the step to step ST 27 and finishes the data reception processing. By contrast with this, if there is a following received OFDM symbol, the step returns to step ST 22, and the following processing is performed based on D/U measured in step ST 24 and in-band C/N acquired in step ST 25.

As described above, according to the present embodiment, by providing: OFDM demodulation section 107 that contains FFT circuit 107c and performs OFDM demodulation of a received OFDM signal; D/U measuring section 106a that measures D/U based on the signal obtained by performing OFDM demodulation; window function processing section 107b provided before FFT circuit 107c; analog filters 201a and 201b that processes the OFDM signal before window function processing section 107b and can control the filter order; and selecting section 203 that can control coefficients of window function processing section 107b and the filter orders of analog filters 201a and 201b based on D/U measured in D/U measuring section 106a, the C/N of the signal obtained by performing OFDM demodulation and the required C/N, it is possible to suppress BER degradation due to window function processing and sufficiently remove undesired waves with a relatively simple configuration and low power consumption.

That is, according to OFDM receiving apparatus 200 of the present embodiment, compared to a conventional receiving apparatus using an analog filter of fixed order, it is possible to reduce the power consumption.

Also, the filter orders and window function coefficients are switched for optimization based on D/U and C/N of a received signal, so that, even when a signal including a strong undesired wave is received, it is possible to acquire received data of good error rate performance with a small size and low power consumption.

Also, although cases have been described above with embodiments where table 300 is used to determine the orders of analog filters and window function coefficients based on D/U and C/N, the present invention is not limited to this, and an essential requirement is to optimize the orders of analog filters and window function coefficients based on quality information of a received signal, and it is equally possible to form a more detailed table by adding parameters indicating the quality of a received signal other than D/U and C/N.

### INDUSTRIAL APPLICABILITY

The OFDM receiving apparatus of the present invention has an advantage of enabling undesired waves included in a received OFDM signal to be removed sufficiently with a relatively simple configuration and low power consumption, and is applicable and suitable to, for example, mobile terminals such as mobile telephones.

1. An orthogonal frequency division multiplexing receiving apparatus comprising:
an orthogonal frequency division multiplexing demodulation section that contains a fast Fourier transform circuit and performs orthogonal frequency division multiplexing demodulation of a received orthogonal frequency division multiplexing signal;
a desired-to-undesired ratio measuring section that measures a desired-to-undesired ratio based on the signal obtained by performing the orthogonal frequency division multiplexing demodulation;
a window function processing section that processes the orthogonal frequency division multiplexing signal before the fast Fourier transform circuit; and
a control section that switches coefficients of the window function processing section based on the desired-to-undesired ratio measured in the desired-to-undesired ratio measuring section.

2. An orthogonal frequency division multiplexing receiving apparatus comprising:
an orthogonal frequency division multiplexing demodulation section that contains a fast Fourier transform circuit and performs orthogonal frequency division multiplexing demodulation of a received orthogonal frequency division multiplexing signal;
a desired-to-undesired ratio measuring section that measures a desired-to-undesired ratio based on the signal obtained by performing the orthogonal frequency division multiplexing demodulation;
a window function processing section that processes the orthogonal frequency division multiplexing signal before the fast Fourier transform circuit;
an analog filter that is provided before the window function processing section and can control a filter order; and
a control section that switches coefficients of the window function processing section and the filter order of the analog filter based on the desired-to-undesired ratio measured in the desired-to-undesired ratio measuring section, a carrier-to-noise ratio of the signal obtained by performing the orthogonal frequency division multiplexing demodulation and a required carrier-to-noise ratio.

3. The orthogonal frequency division multiplexing receiving apparatus according to claim 1, wherein the window function processing section uses a Tukey window function as a window function.
